(19) United States
(12) Patent Application Publication
(10) Pub. No.: US 2015/0310068 A1
(43) Pub. Date: Oct. 29, 2015

(54) Reinforcement Learning Based Document Coding

(71) Applicant: Catalyst Repository Systems, Inc., Denver, CO (US)

(72) Inventors: Jeremy Pickens, Bloomville, NY (US); Bruce Kiefer, Denver, CO (US)

(73) Assignee: Catalyst Repository Systems, Inc., Denver, CO (US)

(21) Appl. No.: 14/264,893

(22) Filed: Apr. 29, 2014

(51) Int. Cl. G06F 17/30

(52) U.S. Cl. CPC G06F 17/30507; G06F 17/30864

(57) ABSTRACT

Systems and methods for enhanced document analysis and identification through a reinforcement learning framework are provided. A system may employ computer based reinforcement learning to interact with large populations of documents to help users achieve a goal. To accomplish this goal, rewards, value functions, states, policies, and actions may be modeled and various tools within the system can be used to achieve the user's goal. As actions are performed, the results of these actions may be used to update state, assess rewards, and update value functions and policy functions. If the goal is not achieved, the system may make adjustments by adjusting policies, pushing the user closer to their goal by methods of reinforcement learning. Once the goal is achieved, such as a confidence that at least a certain percentage of relevant documents have been identified, relevant documents may be provided to a party desiring the documents.

### FIELD

The present disclosure relates generally to systems and methods for analyzing documents, and more particularly, to systems and methods for analyzing documents based on an initial document set analysis and reinforcement learning based on additional document analysis.

### BACKGROUND

A number of different situations commonly arise that require an analysis and identification of certain relevant documents from a relatively large pool of available documents. For example, in litigation, a company's documents may need to be reviewed in order to identify documents that may be relevant to one or more issues in the litigation. In other examples, certain regulatory filings may require review of a number of documents to identify documents that may be relevant to one or more issues in the regulatory filing.

In many instances, the number of documents that require review may be quite large, requiring a significant amount of time and resources in order to complete such a review. While technology improvements and industry competition have helped to improve efficiency, such enhanced efficiency often does not offset increases in the cost of such reviews due to the sheer volume of documents present. In many cases, users are looking to technology to aid in their review. Technology Assisted Review (TAR) can take many forms. Many current systems designed for TAR are based on supervised machine learning. At the core of this process is a belief in inductive reasoning and statistical inference. Inductive systems begin with supervised analysis of a set of finite training documents taken from a larger set of documents. The goal is to create a generalized function induced from the training set that can then be applied to the unseen documents from the same distribution as those selected training. As part of the conceptual framework of inductive learning, the larger population is assumed to be infinite. Once the training set of documents are reviewed, the generalized function induced from the training set may be applied to the remaining documents to identify additional documents that may be relevant to the particular issue of interest.

While TAR may increase efficiency of such document reviews, in some cases it may provide incomplete or inaccurate results. For example, if the training set did not include certain topical subsets of documents having a different format or terminology, documents in the larger set having such formats or terminology may not be identified as being responsive to an identified issue. Thus, in many cases, in order to have confidence in the results from such systems, significant amounts of verification and quality control may be required. Accordingly, more efficient techniques for document analysis and identification are desirable.

### SUMMARY

Various methods, systems, devices, and apparatuses are described for enhanced document analysis and identification through a reinforcement learning framework. Various examples provide a system that employs computer based reinforcement learning to interact with large populations of documents to help users achieve a goal. To accomplish this goal, rewards, states, policies, and actions are modeled and various tools within the system can be used to achieve the user's goal. As actions are performed, the results of these actions may be used to update state, assess rewards, and update value functions and policy functions. If the goal is not achieved, the system may make adjustments by adjusting policies, pushing the user closer to their goal by methods of reinforcement learning.

According to aspects of the disclosure, systems and methods for document analysis and identification are provided. Document analysis and identification may be conducted by accessing a plurality of documents, identifying a subset of the plurality of documents for initial review, and providing documents of the subset to a user for review. User input may be received that includes identification of one or more characteristics of one or more of the subset of documents. The user input for the subset of documents may be analyzed to determine a set of queries associated with the one or more characteristics. For example, the user may identify documents that are subject to attorney-client privilege, and the documents may be analyzed to determine a set of queries to identify similar documents (e.g., documents addressed to particular individuals, documents containing certain language, etc.). The set of queries may then be used to query at least a portion of the plurality of documents and identify a second subset of the plurality of documents that satisfy the set of queries. Reinforcement may be achieved by providing at least one other document of the plurality of documents to the user for review, the at least one other document being outside of the first and second subsets. User review of the other document(s) may be used to update state, assess rewards, and update value functions and policy functions associated with the set of queries. Such a process may be repeated until a predetermined confidence is achieved that relevant documents have been identified.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings.

FIG. 1 is a block diagram illustration of a system that may be used to implement aspects of the present disclosure;

FIG. 2 is another block diagram illustration of a system that may be used to implement aspects of the present disclosure;

FIG. 3 is a flow chart diagram of operational steps according to various aspects of the present disclosure;

FIG. 4 is a block diagram illustration of functional components of various aspects of the present disclosure;

FIG. 5 is a block diagram of operational blocks according to various aspects of the present disclosure; and

FIG. 6 is another block diagram of operational blocks according to various aspects of the present disclosure.

### DETAILED DESCRIPTION

Described embodiments are directed to systems and methods for enhanced document analysis and identification through a reinforcement learning framework. Various examples provide a system that employs computer based reinforcement learning to interact with large populations of documents to help users achieve a goal. To accomplish this goal, rewards, states, policies, and actions may be modeled and various tools within the system can be used to achieve the user's goal. As actions are performed, the results of these actions may be used to update state, assess rewards, and update value functions and policy functions. If the goal is not achieved, the system may make adjustments by adjusting policies, pushing the user closer to their goal through reinforcement learning. Once the goal is achieved, such as a confidence that at least a certain percentage of relevant documents have been identified, relevant documents may be provided to a party that may have requested the documents.

In real-world document reviews, there are typically only a finite number of documents collected. Even if collection is rolling, a case itself has a limited time frame and a limited scope. Thus, the eDiscovery domain is finite, not infinite as is often assumed in inductive systems. Accordingly, there is a mismatch between the assumptions and the common current choices made in TAR. Inductive systems can work for many use cases, but provided herein are improved techniques that behave transductively-applying a working answer more directly to the existing unseen documents. The present disclosure recognizes that eDiscovery users are often more interested in finding relevant documents than they are in finding non-relevant documents. Relevancy may be defined by the user according to a particular criteria, such as responsive, probative, privileged, or other goals. Furthermore, every relevant document that is identified means one fewer relevant document that needs to be found in the remaining documents of the finite number of the plurality of documents.

According to various examples, using technology, other similar relevant documents can be found, freeing up the user to explore uncharted areas of the finite collection of the plurality of documents. According to various aspects of the present disclosure, techniques to reduce the document count, answer many questions, and explore diverse populations is not performed through inductive methods like supervised learning or active learning, but rather through the use of reinforcement learning that allows the user to pursue all of these goals.

Supervised learning is training (inducing a function) with labeled examples, and active learning is a way of picking which examples are to be provided in supervised learning. Reinforcement learning, as provided in various aspects herein, provides a goal that is to select an action so as to maximize a cumulative reward. Rewards, and the state of the system and environment that lead to that reward, are dynamically recalculated, which is necessary in a finite, transductive environment. Unlike supervised learning in which a finite training (learning) phase is followed by an infinite labeling phase, in reinforcement learning every action offers the chance for learning, every reward a chance for reevaluation in a depleting-relevance environment of the best possible path from the current point forward. Induction based systems also commonly make use of sample documents to represent the population. Examples of the present disclosure do not require that step, but can adopt it based on a selection by a user.

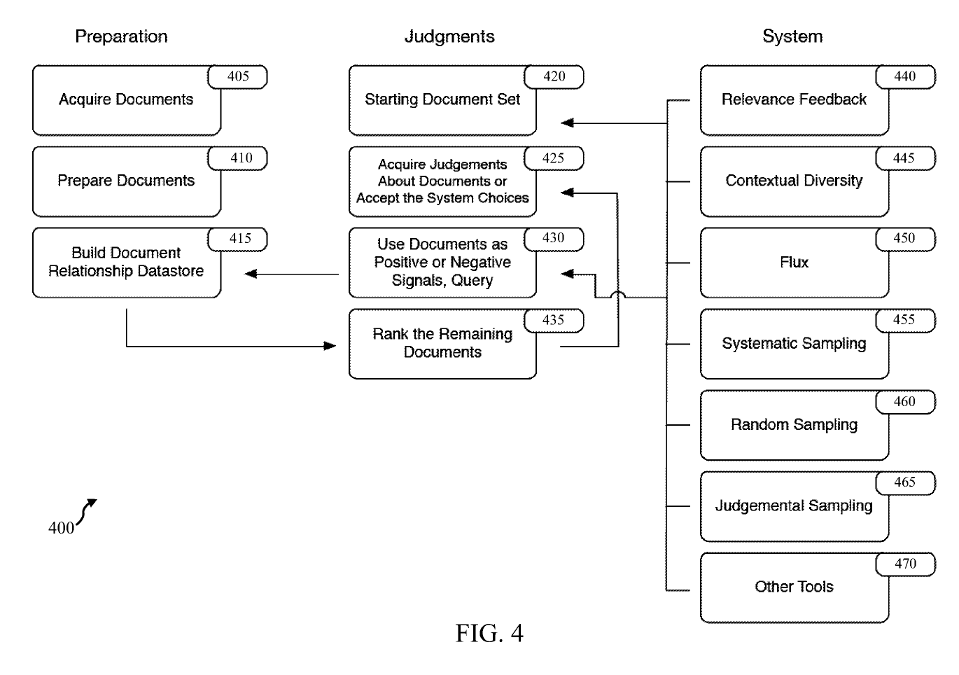

According to examples, a number of tools exist that may be applied in different combinations to achieve many goals. Tools may be provided to work with sample populations, judgmental samples, experts, non-experts, linear review, prioritized review, automated review, and to make tradeoffs in exploration versus exploitation. A user may define a goal and the system can compose a set of tools to achieve that goal (additional details of various tools are discussed with reference to FIG. 4 below). Key benefits include the arbitrary selection of a goal and achieving that goal through flexibility while delivering quality insights into the document population.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

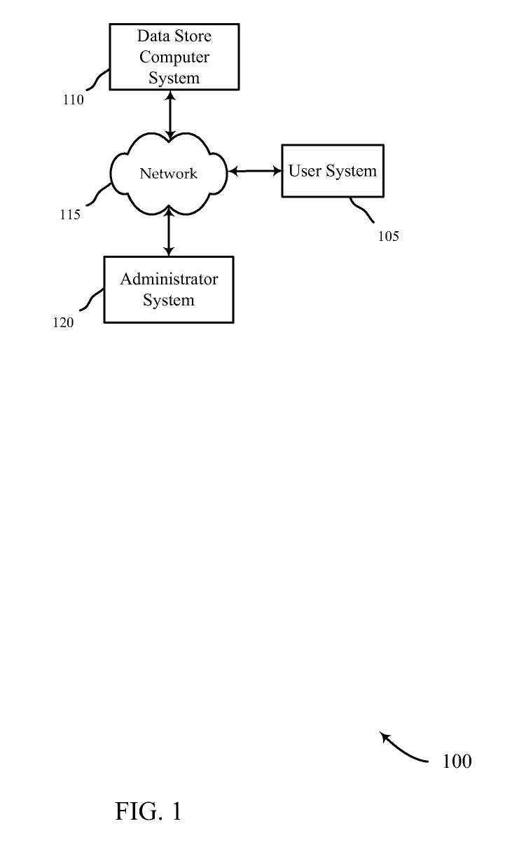

Referring first to FIG. 1, a block diagram illustrates a system 100 according to one embodiment that includes one or more user systems 105. A user system(s) 105 may be one of a number of devices, such as an access terminal, personal computer, a tablet computer, a laptop computer, a smartphone, or other mobile device that communicates voice or data, or any combination of the foregoing. User system(s) 105 may also include a wired or wireless connection to a local area network or the Internet, for example. It will be readily understood that a user system(s) may include any suitable device capable of operating to perform the functions for providing user access to one or more documents and the ability to provide one or more items of information related to the one or more documents, and the particular components illustrated in FIG. 1 are for purposes of illustration and discussion of general concepts described herein.

The user system(s) 105, in the embodiment of FIG. 1, connect to a data store computer system 110 through a network 115. Although a network connection is illustrated in FIG. 1, it will be understood that other alternatives may be used, such as a stand-alone system in which all of the functions described herein are provided in a single computer system, for example. Network 115 may be any suitable network, such networks being well known and need not be described in further detail here. The data store computer system 110, according to various examples, may provide access to user system 105 and provide access to a plurality of documents stored in the data store computer system 110. In some examples, data store computer system 110 may be interconnected with a document database (now shown) that stores the plurality of documents to be analyzed in accordance with the various examples described herein. The data store computer system 110 may, for example, be made up one or more server computers, personal computers, workstations, web servers, or other suitable computing devices, and the individual computing device(s) for a given server may be local or remote from each other.

In various embodiments, the data store computer system 110 receives a plurality of documents to be analyzed and coded. For example, a large number of documents related to a litigation matter may be provided and need to be coded according to one or more issues associated with the litigation. The data store computer system 110 may provide a limited initial set of documents to user system 105 for initial review and coding according to one or more issues related to the documents. For example, in a litigation context it may be desired to identify documents that are protected under the attorney-client privilege. The limited initial set of documents may be selected according to any of a number of techniques. For example, the data store computer system 110 may select randomly from the document set an initial set of documents for review, documents may be selected by a user (e.g., known privileged documents), or a user may perform a keyword search to identify the limited initial set of documents, to name but a few examples. Based on user input related to the limited initial set of documents, the data store computer system may analyze remaining documents of the plurality of documents to identify similar documents that are likely to be coded in the same manner as documents in the limited initial set. According to various examples, the data store computer system 110 may update the state of the system based on the action of analyzing the documents. Based on the updated state of the system, another action might be selected to be executed to find additional documents. For example, if the first action was based on an initial document selected by the user, the next action may be to perform a keyword search. Based on the keyword search, in this example, the data store computer system 110 may provide additional documents to the user system 105 for further review to verify that documents are coded correctly. In some examples, the data store computer system 110 provides additional documents that are both likely to be coded in the same manner as the initial set and likely to not be coded in the same manner at the initial set. By having a user confirm that a document is not to be coded in a particular manner, confidence may be increased that the other documents in the plurality of documents are likely to be coded correctly. Once a confidence level is achieved that the documents of the plurality of documents are likely to be coded correctly, the data store computer system 110 may discontinue providing documents to the user system 105 for review. In some examples, another action may be selected (e.g., random document selection) and documents may be analyzed and coded in a similar manner, until a desired goal is achieved.

In the example of FIG. 1, an administrator system 120 is also interconnected with the network 115, and may provide administrative functions associated with the system. For example, data store computer system 110 may store documents, provide documents for review, and analyze documents to determine if documents are to be coded in a particular fashion. User system(s) 105 may simply be access terminals (e.g., a workstation of a document reviewer) that access a web interface of data store computer system 110. Administrator system 120 may also be an access terminal but may provide administrator credentials to data store computer system 110 to allow for administrative rights associated with the plurality of documents and criteria for review and coding of documents, as well as required confidence criteria for determining that the plurality of documents have been adequately reviewed.

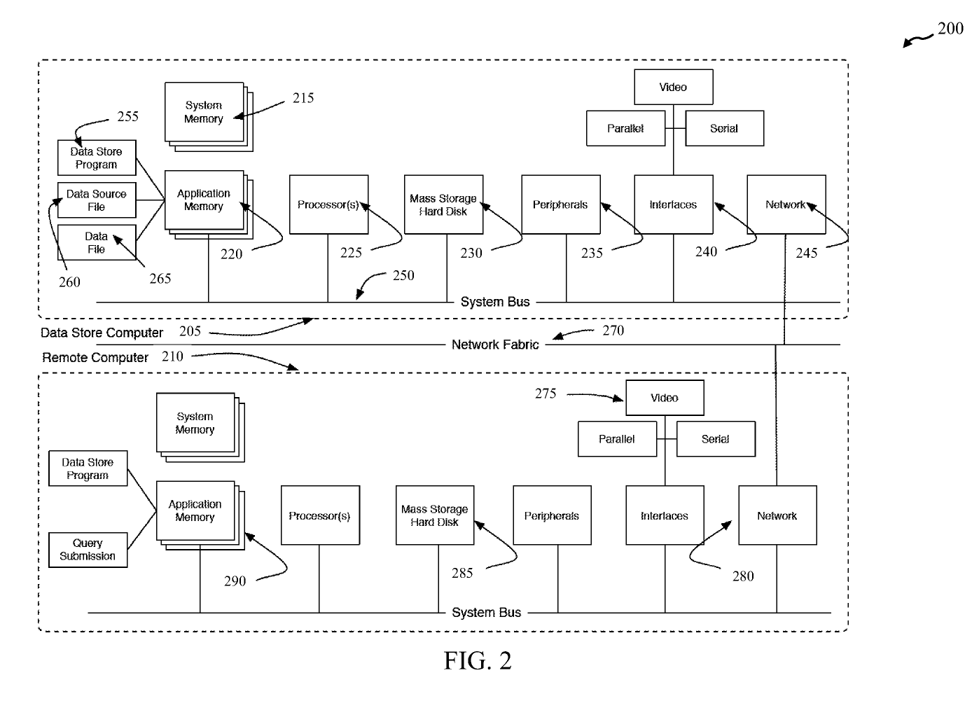

With reference now to FIG. 2, another example of a system 200 that may implement aspects of the disclosure is described. This system is deployed into a computer based system and may include acquisition, parsing, and building a data store related-to the content of the plurality of documents. Once these steps have been completed, similarly as discussed above, a networked set of computers may acquire judgments from one or more users associated with a limited set of initial documents. This may be done, for example, within a document management system or document review system. According to various examples, the system provides the ability to capture users' opinion or judgment about the utility of a document, tracking the document identifier, user, and opinion. For example, the user may identify a document as relevant to a particular issue in a litigation matter. These pieces of information are stored and the document of interest along with the judgment are further parsed and reformatted to become queries used as signals to the system. The queries may be run against the remaining documents of the data store and the system nominates documents that align with the queries either positively (meaning similar documents) or negatively (meaning dissimilar documents). According to certain examples, a number of tools may be provided as will be discussed in more detail below, and may be used to tune the results or aid in exploration of the document population. For example, the system may store the various reinforcement learning action selection probabilities (i.e., policies), value functions, etc., that are derived from the combination of user judgment and reward function, which may be used to select a next policy to use and further refine the results or aid in review of remaining documents.

With continued reference to FIG. 2, this example environment 200 includes two computing systems 205, 210, which may be, for example, personal computers. FIGS. 1 and 2 represent exemplary operating environments for implementing the present invention and, as one of skill in the art can appreciate, there are numerous alternatives for implementation of techniques described herein that may be employed without departing from the intended scope and spirit of the invention. For example, any number of combinations of database elements and server elements may replace the items shown in FIG. 2.

Computer system 205 in this example includes system memory 215 and application memory 220, a processing core including one or more processors 225, access to mass storage 230, peripherals 235, interfaces 240 and commonly a network access device 245. Each item of the computer system 205 is coupled to a system bus 250 for allowing coordinated communication between all of the components. This first computer system 205, in this example, may house data store software and program files 255. Although this is an exemplary setup, those skilled in the art will readily recognize that there are many permutations of this simplified setup including, but not limited to, wireless network, removable storage devices, solid state media devices, processing farms, multiprocessing cores, tablets, phones, various memory enhancements, and improvements on the basic interfaces like USB, Firewire, SATA, SCSI to name a few. A number of programs may be stored on the main storage hard disk 230 and then loaded into memory 215 for execution. One or more components of computer system 105 may implement routines, sub-routines, objects, programs, procedures, components, data structures and other necessary aspects that comprise the data store software and program files 255. The data store program 255 may interact with a data source file 260 and data file 265 to create, delete or manipulate data.

Through the network fabric 270, computer systems 205, 210 may exchange communications using protocols such as TCP/IP via any of a number of media choices, such as Ethernet. Those skilled in the art will understand that there are many permutations of this network fabric and the chosen network fabric is not intended to be limiting in any way. Accordingly aspects of the disclosure are capable of running on any of those permutations. A user or another software program may input queries through the remote computer system 210 using various input devices connected to user interfaces such as, for example, a mouse, keyboard, keypad, microphone or touch screen. A display device is often connected to the system 275 to handle visual interaction with the user, but various examples are capable of running without a visual interface by use of a program or module or subroutine, or an audio interface to handle the input. The remote computer system 210 may be connected to the network 270 through network interface or adapter 280, but could be connected wirelessly, through a modem or directly coupled to the computer running the data store. The remote computer system 210 may run some portion of the program module loaded from hard disk 285 into application memory 290. Various examples may be implemented in any division of client and server workload and this illustration serves only to be an example. Additionally, those skilled in the art will appreciate that the present invention is capable of being implemented in many other configurations including, but not limited to, terminals connected to host servers, handheld devices, mobile devices, consumer consoles, special purpose machines to name a few.

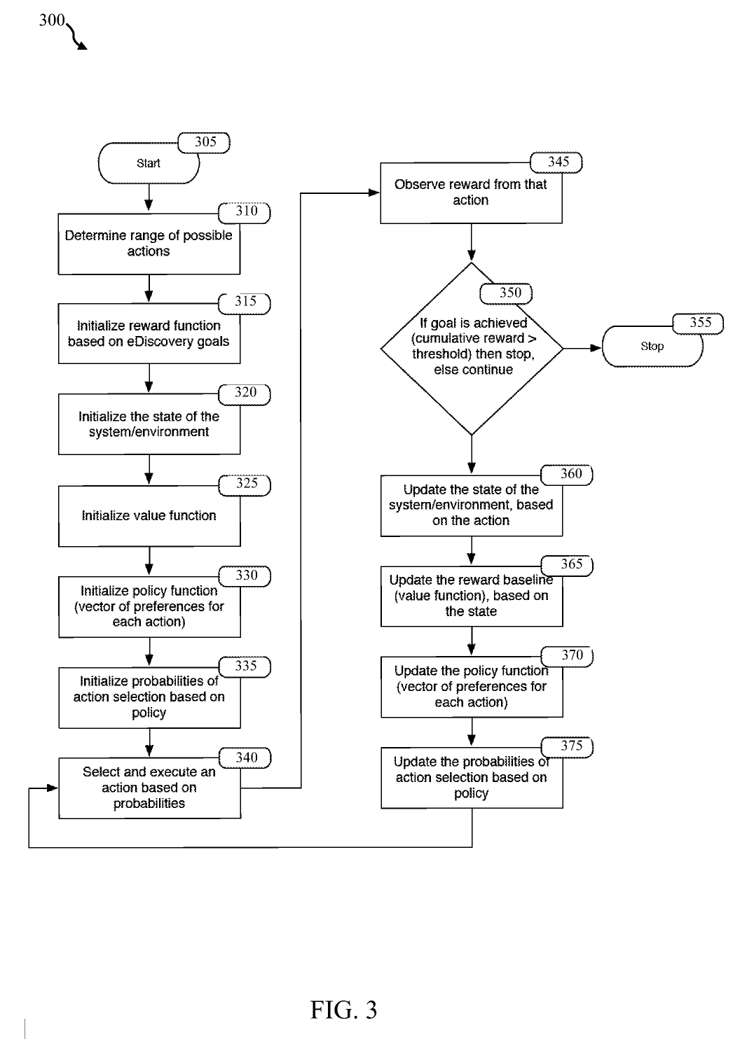

With reference now to FIG. 3, exemplary operations for various aspects of the disclosure are described with respect to flowchart of method 300. The method 300 may be implemented using, for example, the systems 105, 110, and/or 120 of FIG. 1, and/or computer systems 205 and/or 210 of FIG. 2. At block 305, operations are initiated. At block 310, a range of possible actions are determined. Such actions may include, for example, deciding whether to pull a document from the relevance feedback queue, from the contextual diversity queue, or to run a systematic sample, etc. In each of these actions, the user may perform some judging of documents for relevance. At block 315, a reward function is initialized based on document review goals. The reward function may be a result, or combination of factors, that is desired to be maximized For example, a reward function may be a certain confidence that relevant documents have been identified, a cumulative yield of responsive documents, and/or a count of documents that do not have to be manually reviewed by a reviewer. The state of the system/environment is initialized, according to block 320. For example, an initial state may be that no documents are reviewed or identified as likely relevant to a particular characteristic. The value function is initialized at block 325, which may include, for example, an estimate of how good it is for the system to be in a certain state (or in a state and taking a particular action), an increase in cumulative yield, and/or a decrease in a need for manual review by a reviewer.

Continuing with reference to FIG. 3, a value function is initialized at block 325, and a policy function is initialized at block 330. According to various examples, reinforcement learning techniques may estimate value functions of states and/or actions. That is, given that an agent is in a particular state, or in a particular state and is executing a particular action, a value function may estimate the expected future reward from that point forward. Furthermore, based on that value function, a policy function can be estimated or updated so as to prefer certain future actions. There are a number of different methods for estimating value functions and policy functions, including but not limited to temporal difference methods, dynamic programming, and Monte Carlo methods. Estimates can be on-policy or off-policy; that is, an agent can follow one set of action preferences while evaluating the value of having followed another. At block 335, the method may initialize probabilities of action selection based on policy, and at block 340 an action may be selected and executed based on the probabilities. At block 345, a reward from that action is observed. Such a reward may be a change in the confidence of a particular outcome (e.g., identification of relevant eDiscovery documents).

At block 350, it is determined if the goal is achieved. If the goal is achieved, the process stops according to block 355. If the goal is not achieved, the method goes on to update the state of the system/environment based on the action, as indicated at block 360. At block 365, the reward baseline (value function) is updated based on the state. At block 370, the policy function is updated, and at block 375 the method updates the probabilities of action selection based on policy. Following the updates of blocks 360 through 375, the operations of blocks 340 through 350 are repeated, and the method may continue until the goal is achieved.

With reference now to FIG. 4, an example implementation 400 of the reinforcement learning system is described for various aspects of the disclosure. The implementation 400 may be implemented using, for example, the systems 105, 110, and/or 120 of FIG. 1, and/or computer systems 205 and/or 210 of FIG. 2. Broadly, the implementation may be divided into three categories, namely preparation, judgments, and system. In the preparation category, documents may be acquired to load into the system, as indicated at block 405. There are a plurality of ways that this can happen as will be readily recognized by one of skill in the art. For example, acquisition may be through physical media, network transmission, brokers, or other techniques. Preparation may also include preparing documents, as indicated at block 410. Preparation may include, for example, text extraction and/or a determination of whether other than plain text are required to be filtered so that text can be extracted. Again, there are a number of readily suitable alternatives for such preparation, as will be recognized by one of skill in the art. In some examples, binary document file formats may have text extracted, stop words may or may not be applied, encodings may be identified, language may be identified, strings may be tokenized, scanned documents may have OCR analysis performed, image files may have colors and shapes identified, audio files may be converted to text, and computer code files may be parsed into abstract syntax. All or a combination of such preparations, and/or other examples, may be applied to data, and dictionaries or thesauruses may also be applied or constructed.

In the example of FIG. 4, a document relationship datastore may be built, as indicated at block 415. Such a datastore may be built using one or more of a variety of techniques. In some aspects, a basic storage of a document-term matrix may be useful. Indices applied to the matrix can make queries more efficient, and relationships in the document-term matrix can be emphasized including but not limited to frequency analysis, co-occurrence, and proximity. Analysis can be extended beyond the term document matrix to look at qualities of the document including but not limited to styles of writing, sentiment, bias, gender, and phrase preferences. These pieces may be collected and optimized in a datastore that can take the form of a generic relational database, special purpose database, memory structures, or any number of other choices.

Block 420 of FIG. 4 collects an initial set of documents to be analyzed. Again, various alternatives exist for identification of such a starting document set. For example, this can be accomplished with a judgmental sample (e.g., the user selects documents they are familiar with), simple random sample, systematic random sample, or nominated sample (e.g., machines select documents as being representative of the population via frequency, reference, clustering, or other techniques such as contextual diversity). Block 425 acquires judgments about documents, or acquires an acceptance of system choices in cases where the system may provide the starting document set based on one or more user selected criteria. In some examples, a client-server system of some design may be implemented to perform block 425, so that a user can see the document and record a judgment. This can happen synchronously, asynchronously, within batches, or other techniques. The judgments may be recorded electronically so they can be used to influence the querying of the datastore previously described. This can be accomplished through many common techniques, such as using persistent or semi persistent computer memory.

The content of the documents judged at block 425 may be transformed into positive or negative signals via a query mechanism that is run against the datastore, as indicated at block 430. This can be accomplished in a number of ways depending on the choice of data store, network configuration, efficiency, optimizations, or constraints of the total system. During the query phase, positive and negative signals can be used in tandem to understand the population. Ultimately, the system, according to certain examples, determines a ranking of different kinds of possible actions, at block 435. This list is fed back for further judgments by machines or further assessment by other tools. In various embodiments, the system may determine a ranking of a next set of documents, relevance feedback for documents, contextual diversity, and/or a systematic sample of the relevance feedback list (i.e. it is a transformation of the relevance feedback ranking into a subset thereof, which technically is another kind of ranking). Furthermore, in some examples, the system may do relevance feedback (and contextual diversity) on any number of dimensions/modalities.

Software or people can make choices of various tools for use in assisting with defining actions for updating environment or reward functions. In FIG. 4, exemplary tools include relevance feedback 440, contextual diversity 445, flux 450, systematic sampling 455, random sampling 460, judgmental sampling 465, and/or other tools 470. These tools can be used in plurality of combinations to improve the system via the selection of documents, tuning of queries, understanding of the state of the system, progress in the population, and diversity of the population. When referring to contextual diversity, reference is made to prioritizing (ranking) documents in a collection by the likelihood that they are the most about documents that you know that you know nothing about. That is, in the pool of unseen documents, there might be 1000 documents that are about frogs, 50 documents that are about turtles, and 1 document that is about volcanoes. The largest pool of documents that a reviewer knows nothing about is going to be the frog documents, not the volcano document, because there are more of them. And then within those 1000 frog docs, there is going to be a document that is most representative, most central, to all 1000 frog docs. Contextual diversity is a way of detecting that “most about the docs that you know that you know nothing about” document.

Contextual diversity in block 445 may aid the user in exploring the population. This tool may, for example, manipulate positive and negative signals to uncover documents not likely to be uncovered by the current path of exploration. A measurement of flux in block 450 may allow the user to understand if the current exploration path contains outliers or seems to be converging on a bounded set of documents. Sampling tools of blocks 455, 460, and 465 may be used to build sets of documents, provide confidence in the representativeness of the current exploration, and/or be combined with other queries and feedback tools to aid in exploration or confidence to the user. As noted above, tools of blocks 440 through 465 are exemplary, and one or more other or alternative tools 470 may be used alone or in conjunction with the previously described tools.

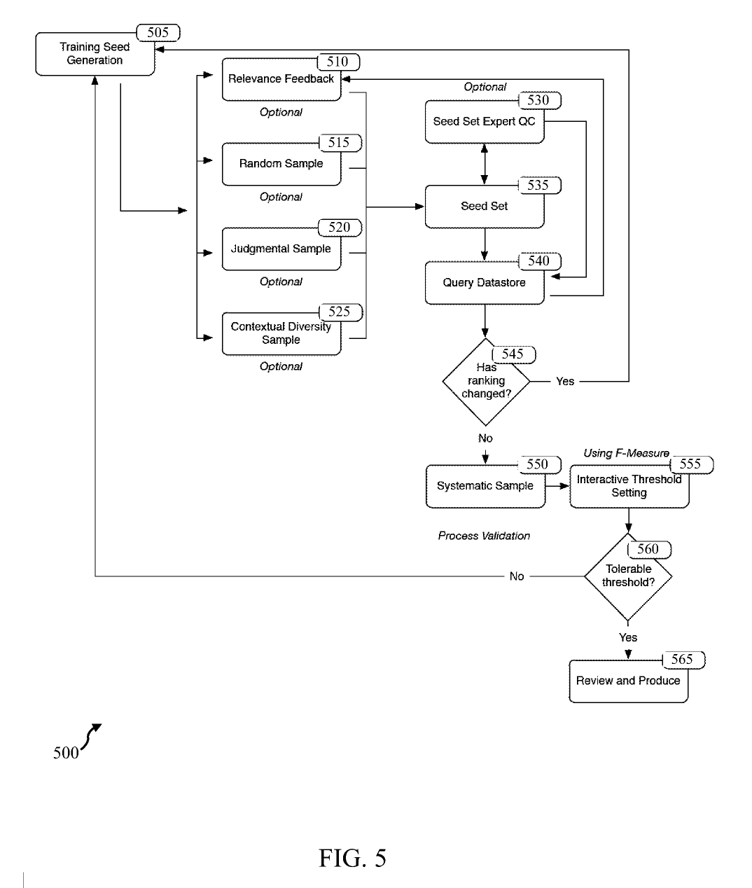

With reference now to FIG. 5, an example of the composability of various aspects shows the tools and system working together in one of a plurality of workflows 500 that may be implemented. In this illustration, a production request for eDiscovery may require a highly defensible coding of documents. In this example, a training seed is generated at block 505. An action may be taken, which can include relevance feedback in block 510, random sampling block 515, judgmental sampling in block 520, or contextual diversity in block in section 525, which may be used to generate a seed set at block 535. A seed set optionally may be reviewed by an expert in some examples, as indicated at block 530. At block 540, the datastore is queried based on the feedback and initial or modified queries, and it is determined at block 545 is the ranking has changed (i.e., have more or fewer relevant documents been identified). If the ranking has changed more than a predetermined amount, a new training seed may be generated for further reinforcement learning. Systematic sampling in block 550, and other tools at blocks 555 and 560 may combine to give users feedback and confidence in the use of the system. Once a confidence threshold has been achieved at block 560, the documents may be reviewed and produced at block 565.

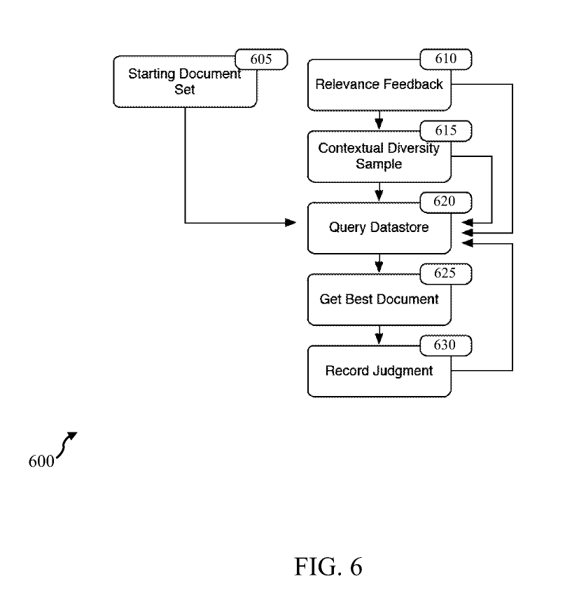

With reference now to FIG. 6, an illustration 600 a different combination of tools used for a simple prioritization of the document review process is described in accordance with certain examples. Users begin with any starting set of documents 605 that is meaningful to them. For example, this could be documents they are familiar with, or a random sample. Judgments are recorded and influence the relevance at block 620 and database queried in block 620. The system uncovers the best documents in block 625 to be reviewed next and the cycle loops. The user can take advantage of contextual diversity sampling 615 to better explore the population or they can ignore this if they plan to review each document.

Thus, various aspects provide reinforcement learning that may allow an agent, interacting with an environment, and learning from that environment to accomplish a goal. The agent interacts with the environment by selecting a number of possible actions that can be performed. The environment responds to the agent by giving a reward (e.g., updated confidence of identification of relevant documents), and the state of the entire system is updated. As discussed, the goal in reinforcement learning is for the agent to maximize its cumulative reward. The reward functions and value function may be defined in different ways for particular reviews such that different policies are created, different actions are selected, and the documents are reviewed in different ways. According to various embodiments, actions include but are not limited to different ways of choosing a document for labeling, for example via relevance feedback on all dimensions (including but not limited to text, date, document owner, file type), via relevance feedback on a single dimension, via contextual diversity or related uncertainty sample, via simple, stratified, systematic, or other random sample, and so on. Actions may also include to whom that document which has been selected for labeling should be routed (including but not limited to a subject matter expert, senior attorney, review manager, contract reviewer, or even opposing counsel for certain trusted subsets of documents).

In some examples, an action may be created which routes document(s) to an automatic (i.e. machine) labeler in addition to or instead of a human labeler. Routing a document to a machine labeler is reminiscent of supervised learning approaches, however, according to various examples, documents may be identified in a dynamic, ongoing, cumulative reward-based decision, rather than an inferred function used to label an infinite number of future exemplars. In such examples, such actions may provide the ability of the system to make these decisions based on a reviewer of a document or based on the document. Thus, some documents may be routed to senior reviewers, some to contract attorneys, and some to machines. Furthermore, based on the rewards observed thereby, preferences for whom to route future documents may be dynamically and iteratively altered. Finally, in some examples, reinforcement learning may provide a document selection mechanism that is redundant (e.g., a document already selected and labeled can be selected and labeled again), for example for quality control or other label uncertainty purposes.

According to some examples, reward functions may include, but are not limited to, the relevance of a document, a monetary cost of labeling a document, an elapsed time spent in labeling a document, a reduced risk of sanctions for not labeling a responsive document, a risk of producing non-relevant but potentially damaging documents, an increased probability of successful case outcome, and even arbitrary, user preference-driven combinations of these and other eDiscovery-appropriate factors. Such rewards may be combined into a single “total reward” function. In certain examples, states of the system may include, but are not limited to, the order in which documents are ranked by an algorithm, the relative change over time of these orderings (i.e., flux), and the (sometimes estimated) number of remaining relevant documents.

While described with reference to identification of documents, such as in an eDiscovery context, aspects of the disclosure system could be used for any large, finite population of objects that can undergo some form of component analysis. For example, a user could provide a body of collected music about jazz and, if components of the songs could be teased out into a data store, collecting judgments about the music may be a way to explore the population. Additionally or alternatively, a user could provide a body of pharmacological research and, if various chemicals and their interactions could be teased out into a data store, collecting judgments about the usefulness of a particular piece of research would also be a way to explore the population.

The detailed description set forth above in connection with the appended drawings describes exemplary embodiments and does not represent the only embodiments that may be implemented or that are within the scope of the claims. The term “exemplary” when used in this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for analyzing and identifying one or more documents of a plurality of documents, comprising:
accessing the plurality of documents;
determining a range of possible actions that may be taken on the plurality of documents;
initializing a reward function based on one or more goals for the analysis and identification of documents, a value function, and a policy function;
selecting a first action of the possible actions to execute on the plurality of documents based on a probability associated with each of the possible actions, the probability associated with each action based on the policy function;
executing the first action on the plurality of documents;
determining a first reward based on executing the first action;
updating the reward function, policy function, and action probabilities based on a first reward;
selecting a second action of the possible actions based on the updated probability associated with each of the remaining possible actions; and
repeating the executing and updating until the one or more goals are achieved.

2. The method of claim 1, wherein the range of possible actions comprises relevance feedback, random sampling, judgmental sampling, contextual diversity sampling, flux calculation, systematic sampling, or uncertainty sampling.

3. The method of claim 1, wherein executing the first action comprises:
providing at least a first document to a user for analysis; and
analyzing one or more documents of the plurality of documents based on the analysis.

4. The method of claim 1, wherein the one or more goals comprise a confidence that relevant documents have been identified.

5. The method of claim 4, wherein the confidence corresponds to a confidence that at least a predetermined percentage of relevant documents of the plurality of documents have been identified.

6. The method of claim 5, wherein the predetermined percentage is selected based on one or more document characteristics being identified.

7. The method of claim 2, wherein updating the reward function, policy function, and probabilities is performed using the results of the range of possible actions.

8. The method of claim 7, wherein further actions are influenced using one or more of:
relevance feedback on one or more document dimensions,
contextual diversity of any subset of the plurality of documents,
an uncertainty sample of any subset of the plurality of documents, or
assessment of simple, stratified, systematic, or random samples of any subset of the plurality of documents.

9. The method of claim 1, wherein an initial subset of the plurality of documents is identified for initial review, the initial subset identified by receiving an identification of known relevant documents.

10. The method of claim 2, wherein the range of possible actions further comprises a type of reviewer to which to route a particular selected document for review.
